(19) United States
(12) Patent Application Publication
(10) Pub. No.: US 2026/0123723 A1
(43) Pub. Date: May 7, 2026

(54) CASE FOR AN ELECTRONIC DEVICE INCLUDING AN ACCESSORY AFFORDANCE

(71) Applicant: BOSE CORPORATION, Framingham, MA (US)

(72) Inventor: Paul C. WILLIAMSON, Worcester, MA (US)

(21) Appl. No.: 18/938,155

(22) Filed: Nov. 5, 2024

(51) Int. Cl. A45C 11/00

(52) U.S. Cl. CPC A45C 11/00; A45C 11/001

(57) ABSTRACT

A case for an electronic device, the case including a lower housing having a cavity to receive the electronic device, an electronic connector configured to couple to the electronic device, and a lid attached to the lower housing with a pivotable joint allowing the lid to rotate between a fully closed position and an open position. The lid is aligned over the cavity in the fully closed position. The lid is angularly displaced allowing for removal of the electronic device in the open position. The lid includes at least one overhang. The at least one overhang is configured to receive engagement features of a cover disposed on the lid. The at least one overhang and the engagement features prevent the cover from displacement when the lid is rotated between the fully closed position and the open position.

### BACKGROUND

The present disclosure generally relates to a case for an electronic device including an accessory affordance. The accessory affordance is configured to retain a case accessory thereby preventing displacement of the case accessory with respect to the case.

### SUMMARY

All examples and features mentioned below can be combined in any technically possible way.

Aspects of the present disclosure provide a case for an electronic device. The case including a lower housing having a cavity to receive the electronic device, and a lid attached to the lower housing with a pivotable joint allowing the lid to rotate between a fully closed position and an open position. The lid is aligned over the cavity in the fully closed position. The lid is angularly displaced allowing for removal of the electronic device in the open position. The lid includes at least one overhang. The at least one overhang is configured to receive engagement features of a cover disposed on the lid. The at least one overhang and the engagement features prevent the cover from displacement when the lid is rotated between the fully closed position and the open position.

In aspects, the at least one overhang is at least partially defined by an outer surface of the lid extending past an outer surface of the lower housing when the lid is in the fully closed position.

In aspects, in the fully closed position, a bottom surface of the lid abuts a top surface of the lower housing and the at least one overhang is at least partially defined by at least a portion of the bottom surface of the lid.

In aspects, the at least one overhang includes a first overhang and a second overhang and the first overhang and the second overhang are discrete and spaced apart from one another.

In aspects, the first overhang is on a first side of the pivotable joint and the second overhang is on a second side of the pivotable joint.

In aspects, the at least one overhang further includes a third overhang and the third overhang is discrete and spaced apart from the first overhang and the second overhang.

In aspects, the third overhang is at least partially between the first overhang and the second overhang.

In aspects, the third overhang is on an opposite side of the lid from the first overhang and the second overhang.

In aspects, the first overhang and the second overhang are at a first height and the third overhang is disposed at a second height.

In aspects, the at least one overhang at least partially circumscribes the lid.

In aspects, the at least one overhang terminates on either end of the pivotable joint.

In aspects, the engagement features include at least one tab and the at least one overhang is configured to receive the at least one tab.

In aspects, the cover includes a lid cover and a lower housing cover, the lid cover is on the lid and includes the engagement features, and the lower housing cover is on the lower housing.

In aspects, the lid cover is prevented from displacement by the at least one overhang and the engagement features.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1A is a front perspective view of an exemplary case in an open position and an electronic device outside of the case, according to one or more aspects.

FIG. 1B is a front perspective view of the case of FIG. 1A in an open position with the electronic device of FIG. 1A in the case, according to one or more aspects.

FIG. 1C is a front view of the case of FIGS. 1A-1B in a closed position with the electronic device of FIGS. 1A-1B in the case, according to one or more aspects.

FIG. 2A is a front perspective view of an exemplary case for an electronic device for use with a case accessory, according to one or more aspects.

FIG. 2B is a rear perspective view of the case of FIG. 2A, according to one or more aspects.

FIG. 2C is a cross-sectional view of the case of FIGS. 2A-2B and the case accessory, according to one or more aspects.

FIG. 3A is a front perspective view of another exemplary case for an electronic device for use with a case accessory, according to one or more aspects.

FIG. 3B is a rear perspective view of the case of FIG. 3A, according to one or more aspects.

FIG. 3C is a cross-sectional view of the case of FIGS. 3A-3B and the case accessory, according to one or more aspects.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In aspects, the disclosure contemplates that terms such as “couples,” “coupling,” “couple,” and “coupled” may include but are not limited to, interference fitting, magnetic fastening, interlocking coupling, adhesively coupling, pinned coupling.

In aspects, the disclosure contemplates that terms such as “couples,” “coupling,” “couple,” and “coupled” may include but are not limited to integrally forming. In aspects, the disclosure contemplates that terms such as “couples,” “coupling,” “couple,” and “coupled” may include but are not limited to direct coupling and/or indirect coupling, such as indirect coupling through intermediate components.

Examples and implementations disclosed herein may be combined with other examples and implementations in any manner consistent with at least one of the principles disclosed herein, and references to “an example,” “an implementation,” “some examples,” “some implementations,” “an alternate example,” “an alternate implementations,” “various examples,” “various implementations,” “one example,” “one implementation,” “one or more examples,” “one or more implementations,” or the like are not necessarily mutually exclusive and are intended to indicate that a particular feature, structure, or characteristic described may be included in at least one example or implementation. The appearances of such terms herein are not necessarily all referring to the same example or implementation.

Also, the phraseology and terminology used herein is for the purpose of description and should not be regarded as limiting. Any references to examples, components, elements, acts, or functions of the headphones herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Aspects of the present disclosure provide systems, apparatus, and methods regarding a case for electronic devices including a case accessory affordance, such as one or more overhangs. The case accessory affordance is configured to engage with a case accessory, such as a case cover, such that the case accessory affordance prevents displacement of the case accessory when the lid of the case is moved between the open position and the closed position.

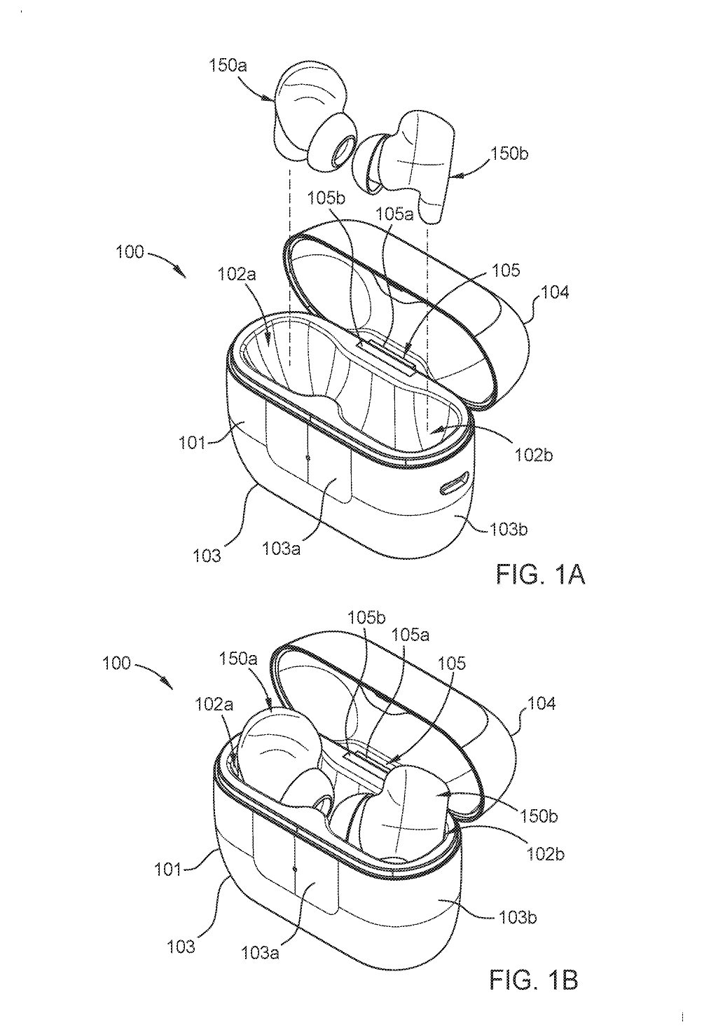

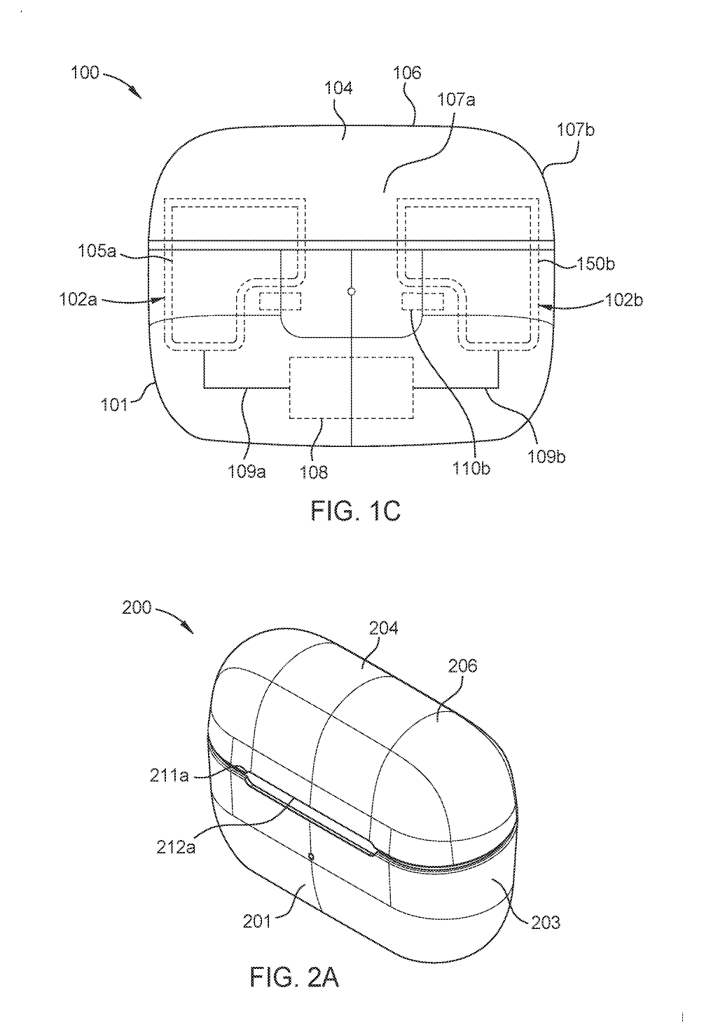

FIGS. 1A-1C illustrate an exemplary case 100 and an exemplary electronic device 150. The case 100 is configured to house the electronic device 150. In the presently illustrated implementation, the exemplary electronic device 150 is wireless earbuds 150 and the case 100 is a case for the wireless earbuds 150. While the illustrated implementation includes wireless earbuds 150 as the exemplary electronic device 150 and the case 100 as a case for wireless earbuds 150, it is to be understood that the electronic device 150 may be any electronic device 150 and the case 100 may be any case 100 configured to hold any electronic device.

FIG. 1A is a front perspective view of the case 100 in an open position with the wireless earbuds 150 disposed outside of the case 100 and a dashed line illustrating how the wireless earbuds 150 are installed into the case 100. FIG. 1B is a front perspective view of the case 100 in an open position with the wireless earbuds 150 in the case 100. FIG. 1C is a front view of the case 100 a closed position with the wireless earbuds 150 disposed in the case 100.

The case 100 includes a lower housing 101 including one or more cavities 102a, 102b configured to receive the wireless earbuds 150a, 150b. In some implementations, the cavities 102a, 102b can be positioned adjacent to each other on opposite sides of a center plane of the case 100. Each cavity 102a, 102b can be sized and shaped to match that of its respective earbud 150a, 150b. Implementations of the disclosure are not limited to any particular shape, configuration or number of cavities 102a, 102b and, in other implementations, the cavities 102a, 102b can have different shapes to accommodate different types of earbuds and/or electronic devices, different configurations, and/or may be a single cavity or may include more than two cavities.

The lower housing 101 includes an outer surface 103 with substantially flat portions 103a and rounded portions 103b. The substantially flat portions 103a may be disposed on the front and/or the rear of the lower housing 101. The rounded portions 103b may be on the bottom and sides of the lower housing 101. Thus, the outer surface 103 may define an elliptical prism with an oval base and a hemispherical bottom. In one or more implementations, the lower housing 101 is partially hemispherical with an oval base and substantially flat portions on the front and back.

The case 100 further includes a lid 104 that is pivotably attached to the lower housing 101 by a hinge 105. The lid 104 is operable (e.g., rotatable) between a fully closed position (as shown in FIG. 1C) and an open position (as shown in FIGS. 1A-1B) by the hinge 105. In the fully closed position, the lid 104 is aligned over the one or more cavities 102a, 102b fully enclosing the wireless earbuds 150a, 150b within the enclosure formed by the lid 104 and the lower housing 101. In the closed position, the bottom surface of the lid 104 abuts the top surface of the lower housing 101. In the open position, the lid 104 is angularly displaced from the lower housing 101 and the cavities 102a, 102b such that a user can remove the wireless earbuds 150a, 150b from the cavities 102a, 102b, or place the wireless earbuds 150a, 150b into the cavities 102a, 102b

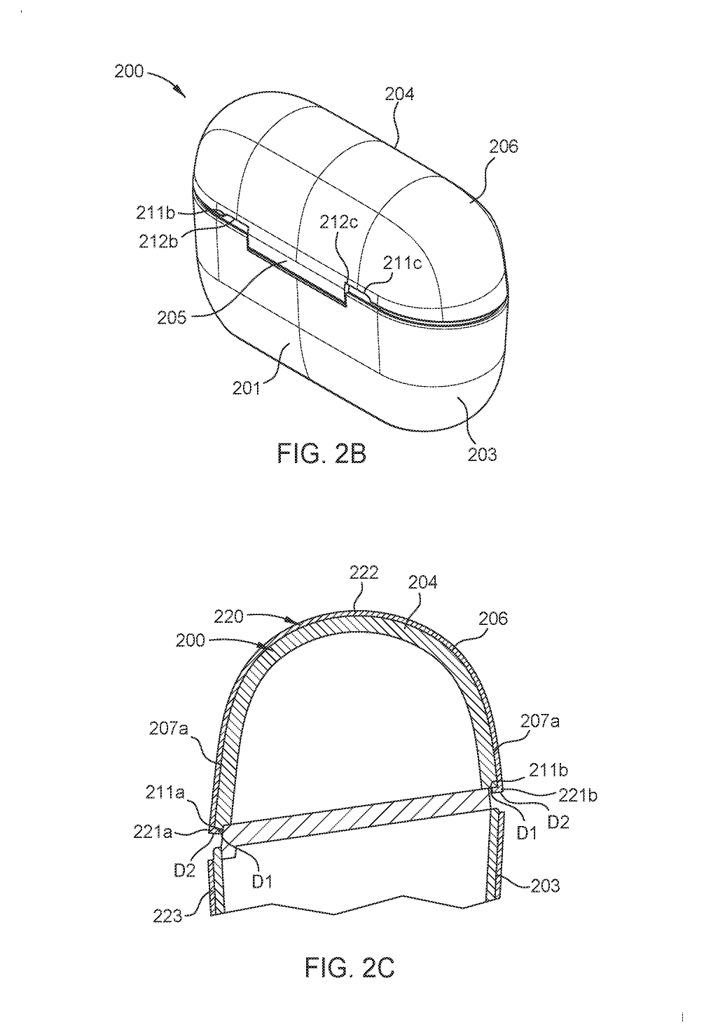

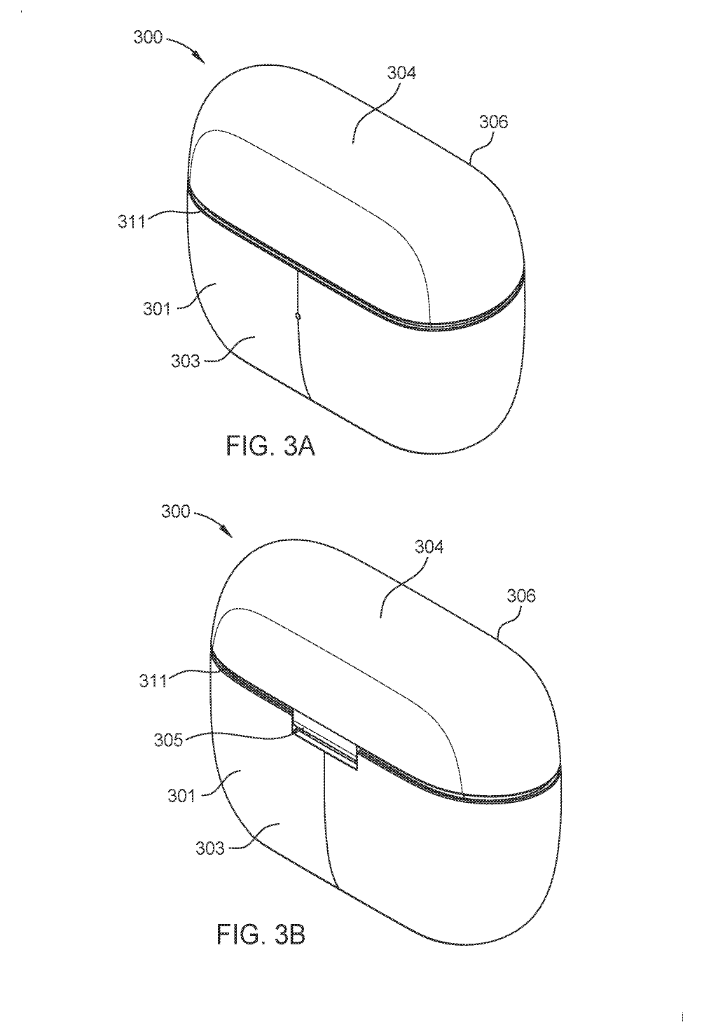

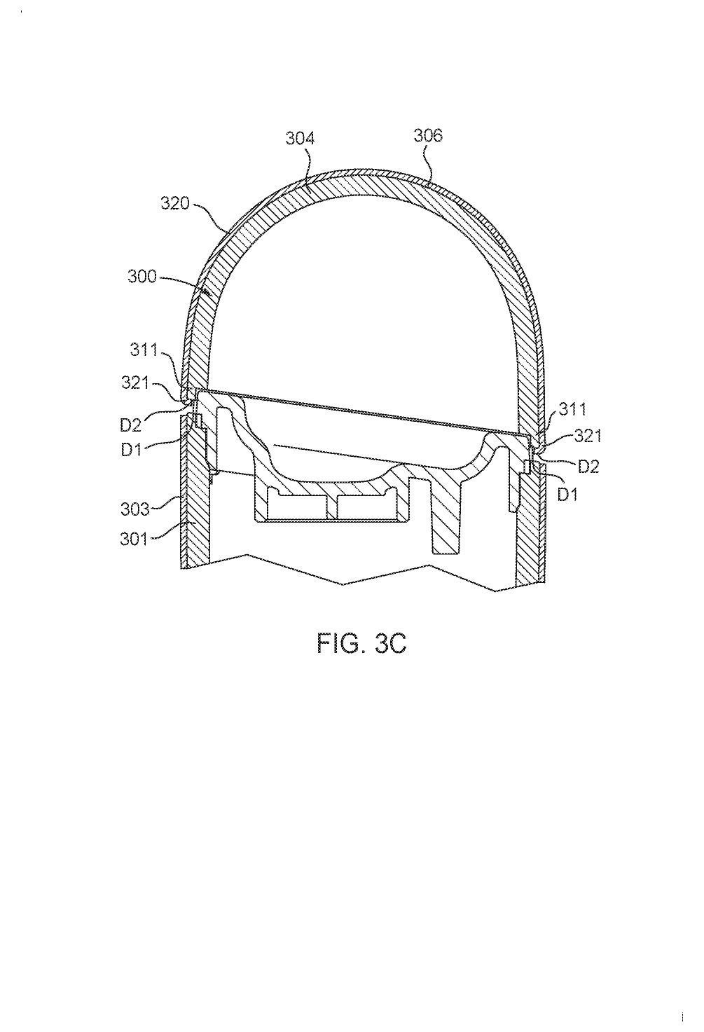

The lid 104 includes an outer surface 106 with substantially flat portions 107a and rounded portions 107b. The substantially flat portions 107a may be disposed on the front and/or the rear of the lid 104. The rounded portions 107b may be on the top and the sides of the lower housing 101. Thus, the outer surface 106 may define an elliptical prism with an oval base and a hemispherical top. In one or more implementations, the lid 104 is at least partially hemispherical with an oval base and substantially flat portions on the front and back. In some implementations, the bottom surface of lid 104 may be angled with respect to a flat (e.g., horizontal) plane. Thus, the bottom surface of the lid 104 at the front and the rear may be at different heights from one another (as best seen in FIGS. 2C and 3C). For instance, the bottom surface of the lid 104 at the front may be at a lower height and the bottom surface of the lid 104 at the rear may be at a higher height.

The hinge 105 pivotably couples the lid 104 to the lower housing 101. The hinge 105 located on the back side of the case 100 bisected by the center plane of the case 100. The hinge 105 may be disposed between the lid 104 and the lower housing 101, such that a portion of the hinge 105a is coupled to the lid 104 and a portion of the hinge 105b is coupled to the lower housing 105. The portion 105a may be a cam that is integrally formed with the lid 104. The portion 105b may be a hinge body that is integrally formed with the lower housing 101. The hinge 105 may further include a pin coupling the hinge body to the cam such that the lid 104 and the lower housing 101 may be pivotably coupled to one another. The hinge 105 may also include a spring or other biasing mechanism to bias the pivotable connection.

In some implementations, the case 100 further includes a charging system 108 configured to charge the wireless earbuds 150a, 150b. In such implementations, the charging system 108 may include one or more connectors 109a, 109b disposed in the case 100 and configured to electrically couple the wireless earbuds 150a, 150b to the charging system 108 thus allowing the charging system 108 to charge the wireless earbuds 150a, 150b. In some implementations, the case 100 further includes one or more magnets 110a, 110b configured to orient and retain the wireless earbuds 150a, 150b within the one or more cavities 102a, 102b.

FIGS. 2A-2C illustrate an exemplary case 200 for use with a case accessory 220, such as a case cover 220 (hereinafter referred to as “case cover 220”). FIG. 2A is a front perspective view of the case 200 for use with the case cover 220. FIG. 2B is a rear perspective view of the case 200 for use with the case cover 220. FIG. 2C is a cross-sectional view of the case 200 and the case cover 220 disposed on the case 200. The cross-section of FIG. 2C is taken slightly off center from the central plane so as to capture the cross section of the front and rear overhangs (as will be discussed below) rather than the hinge 205. For the sake of brevity, all similar components to those described with respect to FIG. 1A-1C have been given similar reference numbers with the same last two digits and a full description of such similar components may not be repeated herein.

The case 200 includes one or more case accessory affordances 211a, 211b, 211c on the lid 204. The one or more case accessory affordances 211a, 211b, 211c are configured to interface with (e.g., engage with or receive a portion of) the case cover 220, to prevent the cover 220 from displacement when the lid 204 is rotated and/or pivoted between the fully closed and the open positions.

In some implementations, such as the illustrated implementation, the one or more case accessory affordances 211a, 211b, 211c include one or more overhangs 211a, 211b, 211c disposed around the circumference of the lid 204 on the lower edge of the lid 204. The one or more overhangs 211a, 211b, 211c may include portions of the bottom surface of lid 204 wherein the outer surface 206 of the lid 204 extends past at least a portion of the outer surface 203 of the lower housing 201 when the case 200 is in the fully closed position. In some implementations, the overhangs 211a, 211b, 211c may extend a distance D1 from the outer surface of the lower housing 201. The one or more overhangs 211a, 211b, 211c allow for one or more cover engagement features 221a, 221b, 221c of the case cover 220 to interface with (e.g., engage with) the case 200 to prevent the cover 220 from displacement when the lid 204 is rotated and/or pivoted between the fully closed and open positions.

In some implementations, such as the illustrated implementation, the overhangs 211a, 211b, 211c are discrete and spaced apart from one another. As an example, overhang 211a may be disposed on the front of the lid 204, that is, the front substantially flat portion 107a of the lid 204 and may be bisected by the central plane of the case 200. Similarly, the overhangs 211b, 211c may be disposed on the rear of the lid 204, that is, the rear substantially flat portion 207a of the lid 204. Including overhang 211a on the front surface of the lid 204 and overhangs 211b, 211c on the rear surface of the lid 204 allow for the cover 220 to be in tension across the lid 204 and allow for engagement on both the front of the lid 204 and the rear of the lid 204. Similarly, the overhangs 211a, 211b, 211c may be disposed on the substantially flat portions 207a of the lid 204 so that the cover engagement features 221 can securely engage with the overhangs 211 on a substantially flat surface. In some implementations wherein the lid 204 has a front portion with the bottom surface of the lid 204 at a first height and the rear portion with the bottom surface of the lid 204 is at a second, higher, height, the overhangs 211a, 211b, 211c may be at different heights corresponding to the lid bottom surface heights.

In some implementations, such as the illustrated implementation, the overhangs 211b, 211c disposed on the rear of the lid 204 may be disposed adjacent to, and on either side of, the hinge 205. Including overhangs 211b, 211c on either side of the hinge 205 allows for secure engagement about the pivotable connection ensuring both sides of the cover 220 are secured on the case 200 about the hinge 205.

In some implementations, such as the illustrated implementations, the overhangs 211a, 211b, 211c are disposed in scalloped portions 212a, 212b, 212c of the lid 204. The scalloped portions 212a, 212b, 212c may define the length of the overhangs 211a, 211b, 211c so as to create spaced apart and discrete overhangs 211a, 211b, 211c.

The cover 220 includes a lid cover portion 222 and a lower housing cover portion 223. The lid cover portion 222 is disposed over, and at least partially covers, the outer surface 206 of the lid 204. The lower housing cover portion 223 is disposed over, and at least partially covers, the outer surface 203 of the lower housing 201. In some implementations the lid cover portion 222 and the lower housing cover portion 223 are connected to one another at the rear side such that the cover 220 is able to open and close similarly to the case 200 while being one integral piece. In one or more implementations, the lid cover portion 222 and lower housing cover portion 223 are flexibly connected to one another at the same pivot point as the hinge 205 thereby allowing for the case 200 to open and close. In one or more of such implementations, the lid cover portion 222 and lower housing cover portion 223 are connected together by a webbing or similar flexible connection.

The cover 220 further includes one or more cover engagement features 221a, 221b, 221c on the lid cover portion 222 configured to interact with (e.g. engage with) with the case accessory affordances 211 (e.g., overhangs 211) of the lid 204 thus preventing displacement of the cover 220 from the lid 204 when the lid 204 is pivoted and/or rotated between the open and fully closed positions. In some implementations, the one or more cover engagement features 221a, 221b, 221c may be disposed on the bottom edge of the lid cover portion 222.

In some implementations, the cover engagement features 221a, 221b, 221c may be protrusions or tabs 221 (hereinafter referred to as “tabs 221”) that extend inwardly (e.g., toward the inside of the case 200) from the bottom edge of the lid cover portion 222 such that they engage with the case 200 underneath the overhangs 211a, 211b, 211c. The tabs 221 may extend a distance D2 inward to engage underneath the overhangs which may equal to or less than D1. Thus, the tabs 221 may engage with all or some of the overhangs 211. For example, the tabs 221 may engage with only a portion of the total length of the overhangs 211.

Similarly to the overhangs 211, the tabs 221 may be discrete tabs 221 and spaced apart along the bottom edge of the lid cover portion 222. The discrete and spaced apart tabs 221a, 221b, 221b are located along the bottom edge of the lid cover portion 222 corresponding to the locations of the overhangs 211a, 211b, 211c of the case 200.

The cover 220 may be made of an elastic type material such that the lower edge of the lid cover portion 222 is stretched so that the tabs 221a, 221b, 221c may engage with the underside of the overhangs 211a, 211b, 211c. In such implementations, the elasticity allows the tabs 221a, 221b, 221c to exert a force on the underside of the overhangs 211a, 211b, 211c due to the tension of the lid cover portion 222 across the top of the lid 204 thus securing the lid cover portion 222 in place.

In some implementations, such as the illustrated implementation, the overhangs 211a, 211b, and 211c are only on the lid 204 and the tabs 221a, 221b, 221c are only on the lid cover portion 223. In such implementations, this may be because of the shape of the lid 204 and the lid cover portion 222 that leads to displacement of the lid cover portion 222 while moving the lid 204 between the open and fully closed positions. However, in some implementations, the lower housing 201 may similarly include overhangs 211 and the lower housing cover portion 203 may include tabs 221.

While only three overhangs 211a, 211b, 211c and three tabs 221a, 221b, 221c are shown, there may be more or less (e.g., 1, 2, 4, 5, 6, or more) overhangs 211 and tabs 221 so long as the number of tabs 221 correlates to the number of overhangs 211. As an example, three overhangs 211 gives the case 220 three anchor points to securely engage with thus preventing displacement when the lid 204 is rotated and/or pivoted between the fully closed and open positions.

FIGS. 3A-3C illustrates another exemplary case 300 for use with a case accessory 320, such as a case cover 320 (hereinafter referred to as “case cover 320”). In the presently illustrated implementation. FIG. 3A is a front perspective view of the case 300 for use with the case cover 320. FIG. 3B is a rear perspective view of the case 300 for use with the case cover 320. FIG. 3C is a cross-sectional view of the case 300 and the case cover 320 disposed on the case 300. The cross-section of FIG. 3C is taken slightly off center from the central plane so as to capture the cross section of the overhang 311 rather than the hinge 305. For the sake of brevity, all similar components to those described with respect to FIGS. 1A-2C have been given similar reference numbers with the same last two digits and a full description of such similar components may not be repeated herein.

In some implementations, such as the presently illustrated implementation, the case 300 may include one overhang 311 rather than one or more discrete and spaced apart overhangs 311 (such as the implementation illustrated in FIGS. 2A-2C). In such implementations, the overhang 311 may circumscribe the entire lower edge of the lid 304 terminating at either side of the hinge 305. Similarly, the cover 320 may include one continuous cover engagement feature 321, such as a tab or protrusion (hereinafter referred to as “tab 321”) corresponding to the continuous overhang 311.

Any one or more components of the cases 100, 200, 300 and covers 220, 320 may be integrally formed together, directly coupled together, and/or indirectly coupled together and are not limited to the specific arrangement of components illustrated in FIGS. 1-3C. Any one or more of the components or embodiments of the cases 100, 200, 300 and covers 220, 320 may be combined in whole or part with any other components or embodiments of the cases 100, 200, 300 and covers 220, 320.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A case for an electronic device, the case comprising:
a lower housing having a cavity to receive the electronic device; and
a lid attached to the lower housing with a pivotable joint allowing the lid to rotate between a fully closed position, wherein the lid is aligned over the cavity, and an open position, wherein the lid is angularly displaced allowing for removal of the electronic device, the lid comprising at least one overhang, wherein the at least one overhang is configured to receive engagement features of a cover disposed on the lid, and wherein the at least one overhang and the engagement features prevent the cover from displacement when the lid is rotated between the fully closed position and the open position.

2. The case of claim 1, wherein the at least one overhang is at least partially defined by an outer surface of the lid extending past an outer surface of the lower housing when the lid is in the fully closed position.

3. The case of claim 1, wherein in the fully closed position, a bottom surface of the lid abuts a top surface of the lower housing, and wherein the at least one overhang is at least partially defined by at least a portion of the bottom surface of the lid.

4. The case of claim 1, wherein the at least one overhang comprises a first overhang and a second overhang, and wherein the first overhang and the second overhang are discrete and spaced apart from one another.

5. The case of claim 4, wherein the first overhang is disposed on a first side of the pivotable joint and the second overhang is disposed on a second side of the pivotable joint.

6. The case of claim 5, wherein the at least one overhang further comprises a third overhang, and wherein the third overhang is discrete and spaced apart from the first overhang and the second overhang.

7. The case of claim 6, wherein the third overhang is at least partially disposed between the first overhang and the second overhang.

8. The case of claim 6, wherein the third overhang is disposed on an opposite side of the lid from the first overhang and the second overhang.

9. The case of claim 4, wherein the first overhang and second overhang are disposed at a first height and the third overhang is disposed at a second height.

10. The case of claim 1, wherein the at least one overhang at least partially circumscribes the lid.

11. The case of claim 10, wherein the at least one overhang terminates on either end of the pivotable joint.

12. The case of claim 1, wherein the engagement features comprise at least one tab, and wherein the at least one overhang is configured to receive the at least one tab.

13. The case of claim 1, wherein the cover includes a lid cover and a lower housing cover, the lid cover is disposed on the lid and includes the engagement features, and wherein the lower housing cover is disposed on the lower housing.

14. The case of claim 1, wherein the lid cover is prevented from displacement by the at least one overhang and the engagement features.
